(19) United States
(12) Patent Application Publication
(10) Pub. No.: US 2019/0245796 A1
(43) Pub. Date: Aug. 8, 2019

(54) METHOD FOR DATA RATE SWITCHING IN A HOME APPLIANCE

(71) Applicant: Haier US Appliance Solutions, Inc., Wilmington, DE (US)

(72) Inventors: Chad Michael Helms, Louisville, KY (US); Joseph Mark Brian, Louisville, KY (US)

(21) Appl. No.: 15/890,483

(22) Filed: Feb. 7, 2018

(51) Int. Cl. H04L 12/825; H04L 12/26; H04Q 9/00

(52) U.S. Cl. CPC H04L 47/263; H04L 43/103; H04Q 2213/13561; H04Q 2209/75; H04Q 9/00

(57) ABSTRACT

A method for data rate switching in an appliance that is connected to a network includes polling data at a first rate when a value of a status of the appliance is a first value, transmitting the data polled at the first rate from the appliance via the network, polling data at a second rate when the value of the status of the appliance is a second value, and transmitting the data polled at the second rate from the appliance via the network.

### FIELD OF THE INVENTION

The present subject matter relates generally to network connected home appliances.

### BACKGROUND OF THE INVENTION

Network connected appliances are increasing popular. One benefit of network connected appliances is the ability to transmit data from the appliance to the appliance manufacturer. Such data has many uses. For example, the data can assist the appliance manufacturer with diagnosing the appliance during a service visit. Thus, a network connected appliance may be more easily repaired relative to a non-network connected appliance. As another example, the data can assist the appliance manufacturer with determining usage patterns for the appliances. The usage patterns can improve future appliance designs.

Current network connected appliances generally transmit data at a fixed rate. Thus, the appliance transmits data at the fixed rate whether the appliance is operating or deactivated, and this can lead to repetitive, low value data collection. Selecting an appropriate fixed rate for data collection can also be difficult. A high fixed rate can strain network capabilities while a low fixed rate provides reduced data resolution.

### BRIEF DESCRIPTION OF THE INVENTION

The present subject matter provides a method for data rate switching in an appliance that is connected to a network. The method includes polling data at a first rate when a value of a status of the appliance is a first value, transmitting the data polled at the first rate from the appliance via the network, polling data at a second rate when the value of the status of the appliance is a second value, and transmitting the data polled at the second rate from the appliance via the network. Additional aspects and advantages of the invention will be set forth in part in the following description, or may be apparent from the description, or may be learned through practice of the invention.

In a first example embodiment, a method for data rate switching in an appliance that is connected to a network includes polling data from a sensor of the appliance at a first rate when the appliance is in a deactivated mode and transmitting the data polled at the first rate from the appliance via the network. The method also includes polling data from the sensor at a second rate when the appliance is in an activated mode and transmitting the data polled at the second rate from the appliance via the network. The second rate is greater than the first rate.

In a second example embodiment, a method for data rate switching in an appliance that is connected to a network includes polling data from a controller of the appliance at a first rate when the appliance is in a deactivated mode and transmitting the data polled at the first rate from the appliance via the network. The method also includes polling data from the controller at a second rate when the appliance is in an activated mode and transmitting the data polled at the second rate from the appliance via the network. The second rate is greater than the first rate.

In a third example embodiment, a method for data rate switching in an appliance that is connected to a network includes polling data from a controller of the appliance at a first rate when a value of a status of the appliance is a first value and transmitting the data polled at the first rate from the appliance via the network. The method also includes polling data from the controller at a second rate when the value of the status of the appliance is a second value. The second value is different from the first value. The method further includes transmitting the data polled at the second rate from the appliance via the network. The second rate is greater than the first rate.

In a fourth example embodiment, a method for data rate switching in an appliance that is connected to a network includes polling data from a sensor of the appliance at a first rate when a value of a status of the appliance is a first value and transmitting the data polled at the first rate from the appliance via the network. The method also includes polling data from the sensor at a second rate when the value of the status of the appliance is a second value. The second value is different from the first value. The method further includes transmitting the data polled at the second rate from the appliance via the network. The second rate is greater than the first rate.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic view of a network connected appliance according to an example aspect of the present subject matter.

FIG. 2 is a chart of example poll rates for the example network connected appliance of FIG. 1 in various operating states.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

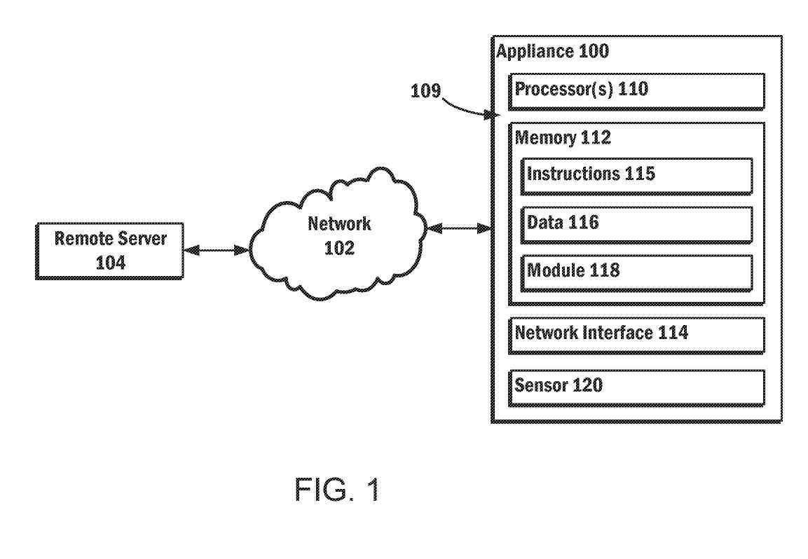

FIG. 1 is a schematic view of a network connected appliance 100 according to an example aspect of the present subject matter. Appliance 100 is connectable to a network 102. Thus, e.g., appliance 100 may communicate with a remote server 104 via network 102. In particular, appliance 100 may transmit data, e.g., related to operation of appliance 100, from appliance 100 to remote server 104 via network 102. As discussed in greater detail below, appliance 100 includes features for adjusting a data polling rate based upon another data value within appliance 100. Thus, appliance 100 may avoid transmitting repetitive, low value data while also allowing collection of data at sufficient resolution.

Appliance 100 includes one or more processors 110, a memory 112, and a network interface 114. As used herein, an appliance can be any machine or device for performing a specific task that also includes features for connecting to a network, including, without limitation, a clothes dryer, a clothes washer, a dishwasher, a refrigerator, a stove, an oven, a microwave, a cooktop, a range hood, a window AC unit, an HVAC system controller, a water heater, etc. Network interface 114 of appliance 100 can include any suitable components for interfacing with one more networks, such as network 102. For example, network interface 114 of appliance 100 may include transmitters, receivers, ports, controllers, antennas, or other suitable components.

The processor(s) 110 of appliance 100 can be any suitable processing device, such as a microprocessor, microcontroller, integrated circuit, or other suitable processing device. The memory 112 of appliance 100 can include any suitable computing system or media, including, but not limited to, non-transitory computer-readable media, RAM, ROM, hard drives, flash drives, or other memory devices. The memory 112 of appliance 110 can store information accessible by processor(s) 110 of appliance 100, including instructions 115 that can be executed by processor(s) 110 to control various components of appliance 100 to provide appliance functionality and data 116. Thus, the combination of one or more processors 112 and memory 114 may correspond to a controller configured to implement various programs or methods to operate appliance 100, and processors 110 and memory 112 may be collectively referred to herein as a controller 109.

A module 118 is included or stored in memory 112 of appliance 100. It will be appreciated that the term “module” refers to computer logic utilized to provide desired functionality. Thus, a module can be implemented in hardware, application specific circuits, firmware and/or software controlling a general purpose processor. In one embodiment, modules are program code files stored on the storage device, loaded into memory and executed by a processor or can be provided from computer program products, for example computer executable instructions, that are stored in a tangible computer-readable storage medium such as RAM, hard disk or optical or magnetic media. Thus, while module 118 is shown stored in memory 112 of appliance 100 in the example embodiment shown in FIG. 1, module 118 may be stored in or implemented by any other suitable component of system 100 in alternative example embodiments.

Data 116 may be collected in various manners within appliance 100. For example, as shown in FIG. 1, appliance 100 may include a sensor 120. Sensor 120 may be in communication with controller 109. Thus, controller 109 may receive one or more signals from sensor 120, and controller 109 may store the one or more signals within memory 112 as data 116. Sensor 120 may be one of various appliance sensors. For example, sensor 120 may be a turbidity sensor, a temperature sensor, a rotational speed sensor, a voltmeter, an ammeter, a pressure sensor, a proximity sensor, a flowmeter, a touch sensor, a door switch, etc. Thus, e.g., controller 109 may receive temperature measurements from sensor 120, and controller 109 may store the temperature measurements from sensor 120 within memory 112 as data 116. As another example, controller 109 may receive one or more signals from sensor 120, and controller 109 may perform calculations with values of the one or more signals from sensor 120 with processor(s) 110 to compute data 116. Thus, data 116 may be computed with controller 109, e.g., based upon one or more signals from sensor 120.

Data 116 may correspond to various operational aspects of appliance 100. For example, when appliance 100 is a dishwasher, sensor 120 may be a turbidity sensor, and data 116 may correspond to the turbidity value of wash fluid within appliance 100. As another example, when appliance 100 is a clothes washer, sensor 120 may be a rotational speed sensor, and data 116 may correspond to the rotational speed of a drum of appliance 100. As yet another example, when appliance 100 is an oven, sensor 120 may be a temperature sensor, and data 116 may correspond to the temperature of a cooking chamber of appliance 100. As an additional example, when appliance 100 is a clothes washer, data 116 may correspond to the out of balance value calculations from controller 109. Data 116 may also corresponds to electrical relay states within appliance 100. Other operational aspects of appliance 100 for data 116 are also within the scope of the present subject matter.

Data 116 is useful, e.g., with diagnosing appliance 100 during a service call and/or with determining a usage pattern of appliance 100. Thus, appliance 100 may transmit data 116 to remote server 104 via network 102 to allow access to data 116 for diagnostic or analytic purposes. Appliance 100 may transmit data 116 in a manner that increases efficiency relative to known network connected appliance while retaining suitable data resolution.

An example method for operating appliance 100 will now be described. The method generally provides for data rate switching in appliance 100. Thus, the method allows for efficient transfer of data 116 over network 102. It will be understood that while discussed below in a certain sequence, the method may be performed in any suitable sequence in alternative example embodiments. Thus, the method is not limited to the particular sequence described below.

The method includes polling data 116 at various rates. In particular, data 116 may be polled at a first rate when a value of a status of appliance 100 is a first value. Data 116 may also be polled at a second rate when the value of the status of appliance 100 is a second value. Data 116 may be polled at the first and second rates directly from sensor 120 or from controller 109.

The first and second values of the status of appliance 100 are different. Thus, data 116 may be polled at the first rate in one status of appliance 100, and data 116 may be polled at the second rate in another status of appliance 100. The status of appliance 100 may correspond to various operational aspects of appliance 100. For example, the status may be an operating state of appliance 100, i.e., whether appliance 100 is actively performing a specific task associated with appliance 100. Thus, the status may be an activated mode when appliance 100 is actively performing the specific task associated with appliance 100. Conversely, the status may be a deactivated mode when appliance 100 is not actively performing the specific task associated with appliance 100. Accordingly, when appliance 100 is a washing machine appliance, the status may be the activated mode when appliance 100 is washing clothes while the status may be the deactivated mode when appliance 100 is not washing clothes. Similarly, when appliance 100 is an oven appliance, the status may be the activated mode when appliance 100 is heating a cooking chamber while the status may be the deactivated mode when appliance 100 is not heating the cooking chamber. Other operating states of appliance 100 are also within the scope of the present subject matter. For example, the status may be whether a diagnostic mode is activated within controller 109. As another example, the status may be set by the remote server 104. Thus, the value of the status of appliance 100 may be selectable at remote server 104 and transmitted to appliance 100 via network 102.

Data 116 that is polled at the first rate is transmitted to remote server 104 via network 102. Thus, data 116 polled at the first rate may be made available to remote server 104 through network 102. Data 116 polled at the first rate may have a relatively low resolution. Thus, e.g., data 116 polled at the first rate may be utilized to monitor appliance 100 when appliance 100 is not actively performing a specific task associated with appliance 100.

Data 116 that is polled at the second rate is also transmitted to remote server 104 via network 102. Thus, data 116 polled at the second rate may be made available to remote server 104 through network 102. Data 116 polled at the second rate may have a relatively high resolution. Thus, e.g., data 116 polled at the second rate may be utilized to monitor appliance 100 when appliance 100 is actively performing the specific task associated with appliance 100.

As may be seen from the above, the second rate may be greater than the first rate. As a particular example, the second rate may be no less than ten times greater than the first rate. Such difference between the first and second rates may advantageously assist appliance 100 with avoiding transmission of repetitive, low value data while also allowing collection of data at sufficient resolution. In particular, transmitting data 116 collected at the first rate when appliance 100 is not actively performing a specific task associated with appliance 100 may avoid transmission of repetitive, low value data. Conversely, transmitting data 116 collected at the second rate when appliance 100 is actively performing a specific task associated with appliance 100 may provide collection of data 116 at a desired resolution.

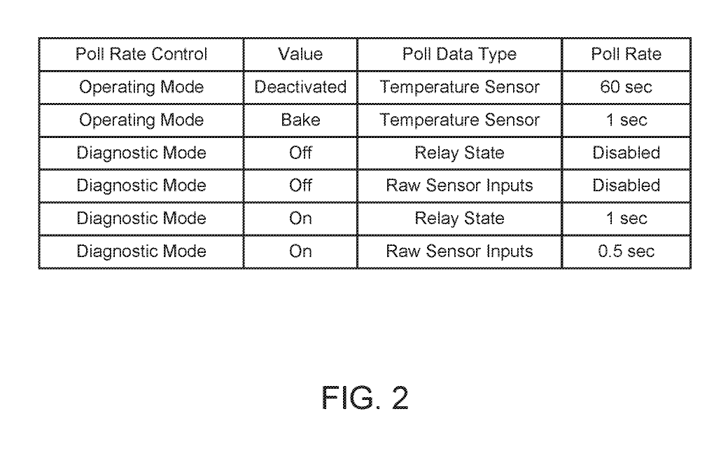

It will be understood the first and second rates may be various values. For example, the first rate is zero in certain example embodiments. Thus, when appliance 100 is deactivated and not actively performing a specific task associated with appliance 100, appliance 100 may transmit no data 116 to remote server 104 via network 102. Example poll rates are discussed in greater detail below in the context of FIG. 2 which is a chart of example poll rates appliance 100 in various operating states. In FIG. 2, appliance 100 is an oven appliance. As may be seen in FIG. 2, sensor 120 may be polled every sixty seconds (60 sec.) when the operating mode of appliance 100 is “deactivated,” i.e., when appliance 100 is off. Conversely, sensor 120 may be polled every second (1 sec.) when the operating mode of appliance 100 is “Bake,” i.e., when appliance 100 is on or activated. In addition, the poll rates may be modified based upon a diagnostic mode status of appliance 100. As may be seen in FIG. 2, raw data from sensor 120 may not be polled when the diagnostic mode is “off.” Conversely, raw data from sensor 120 may be polled every half-second (0.5 sec.) when the diagnostic mode is “on.” In addition, relay states within appliance 100 may not be polled when the diagnostic mode is “off,” and the relay states within appliance 100 may be polled every second (1 sec.) when the diagnostic mode is “on.” It will be understood that these poll rates are provided by way of example only. Other poll rates may be used in alternative example embodiments.

As may be seen from the above, the present subject matter provides a method for adjusting the data rate of a network connected appliance based on system status or control from a remote server. The network connected appliance receives a list of all data to send to the remote server, with a specified data rate for each type of data. Each type of data may have multiple poll rates or data rate configurations that are based on values of other data in the system, i.e., a poll rate controlling data. The poll rate controlling data can be written from the appliance or from the remote server. The poll rate can also be set to completely disable updates to the remote server for a specific type of data. This provides the ability to increase the frequency of data updates to the remote server during certain operations of the appliance. In particular, the method allows for increased data resolution while the appliance is operating while reducing unnecessary overhead from sending data while the appliance is not operating. It also allows for enabling types of data remotely that are not communicated to the remote server in known network connect appliance. In particular, the method allows for enabling additional data for diagnostics and troubleshooting.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for data rate switching in an appliance that is connected to a network, comprising:
polling data from a sensor of the appliance at a first rate when the appliance is in a deactivated mode;
transmitting the data polled at the first rate from the appliance via the network;
polling data from the sensor at a second rate when the appliance is in an activated mode; and
transmitting the data polled at the second rate from the appliance via the network,
wherein the second rate is greater than the first rate.

2. The method of claim 1, wherein the sensor is a turbidity sensor, a temperature sensor or a rotational speed sensor.

3. The method of claim 1, wherein the second rate is no less than ten times greater than the first rate.

4. The method of claim 1, wherein the first rate is zero.

5. The method of claim 1, wherein the appliance is a dishwasher appliance, an oven appliance, a washing machine appliance, a dryer appliance, a water heater appliance or an air conditioning appliance.

6. A method for data rate switching in an appliance that is connected to a network, comprising:
polling data from a controller of the appliance at a first rate when the appliance is in a deactivated mode;
transmitting the data polled at the first rate from the appliance via the network;
polling data from the controller at a second rate when the appliance is in an activated mode; and
transmitting the data polled at the second rate from the appliance via the network,
wherein the second rate is greater than the first rate.

7. The method of claim 6, wherein the second rate is no less than ten times greater than the first rate.

8. The method of claim 6, wherein the first rate is zero.

9. The method of claim 6, wherein the appliance is a dishwasher appliance, an oven appliance, a washing machine appliance, a dryer appliance, a water heater appliance or an air conditioning appliance.

10. A method for data rate switching in an appliance that is connected to a network, comprising:
polling data from a controller of the appliance at a first rate when a value of a status of the appliance is a first value;
transmitting the data polled at the first rate from the appliance via the network;
polling data from the controller at a second rate when the value of the status of the appliance is a second value, the second value different from the first value; and
transmitting the data polled at the second rate from the appliance via the network,
wherein the second rate is greater than the first rate.

11. The method of claim 10, wherein the second rate is no less than ten times greater than the first rate.

12. The method of claim 10, wherein the first rate is zero.

13. The method of claim 10, wherein the appliance is a dishwasher appliance, an oven appliance, a washing machine appliance, a dryer appliance, a water heater appliance or an air conditioning appliance.

14. The method of claim 10, further comprising receiving the value of the status of the appliance from a remote server via the network.

15. A method for data rate switching in an appliance that is connected to a network, comprising:
polling data from a sensor of the appliance at a first rate when a value of a status of the appliance is a first value;
transmitting the data polled at the first rate from the appliance via the network;
polling data from the sensor at a second rate when the value of the status of the appliance is a second value, the second value different from the first value; and
transmitting the data polled at the second rate from the appliance via the network,
wherein the second rate is greater than the first rate.

16. The method of claim 15, wherein the sensor is a turbidity sensor, a temperature sensor or a rotational speed sensor.

17. The method of claim 15, wherein the second rate is no less than ten times greater than the first rate.

18. The method of claim 15, wherein the first rate is zero.

19. The method of claim 15, wherein the appliance is a dishwasher appliance, an oven appliance, a washing machine appliance, a dryer appliance, a water heater appliance or an air conditioning appliance.

20. The method of claim 15, further comprising receiving the value of the status of the appliance from a remote server via the network.
